(19) United States
(12) Patent Application Publication
(10) Pub. No.: US 2006/0261505 A1
(43) Pub. Date: Nov. 23, 2006

(54) Method for treating the internal surfaces of industrial bulidings

(76) Inventors: Benoit Bissonnette, Cap Rouge (CA); Marc Jolin, Quebec (CA); Denis Beaupre, Ste Catherine de la Jacques Cartier (CA); Francois Duchaine, Stoneham (CA)

Correspondence Address: LADAS & PARRY LLP, 224 SOUTH MICHIGAN AVENUE, SUITE 1600, CHICAGO, IL, 60604, US

(21) Appl. No.: 11/212,051

(22) Filed: Aug. 25, 2005

Related U.S. Application Data
(60) Provisional application No. 60/603,999, filed on Aug. 25, 2004.

(51) Int. Cl. B29C 73/00; B05D 3/00

(52) U.S. Cl. 264/36.2; 264/129; 264/265; 427/140; 427/299

(57) ABSTRACT

A method for treating, such as repairing, protecting, sanitizing, and facilitating sanitation of inner surfaces of industrial buildings. This method comprises preparing an inner building surface that is to be treated so as to render the surface able to receive a calcium aluminate-based cement-based mortar with which the deficiencies of the surface are corrected. The surface is then coated with two materials: a primary coating, which provides a regular surface and enhances the adhesion characteristics of the resurfacing system and a final coating such as poly-urea.

### CROSS REFERENCE TO RELATED APPLICATIONS

This application is claims priority on U.S. provisional application No. 60/603,999 filed on Aug. 25, 2004 and which is herein incorporated by reference.

### FIELD OF THE INVENTION

The present invention relates to a method for treating such as repairing, protecting, sanitizing and facilitating sanitation of the internal surfaces of industrial buildings. More specifically, the present invention relates to a method for treating the internal surfaces of agro-food, medical buildings and the like.

### BACKGROUND OF THE INVENTION

The agro-food industry and the medical care institutions in particular are submitted to more and more stringent regulations with regards to the sanitary condition of their facilities. Very significant progress has been recorded in recent years with more effective maintenance protocols, the availability of sophisticated cleaning systems and detergents, the development of disposable or anti-bacterial materials, etc. Nevertheless, there still remain flaws in the sanitizing processes due to the difficulty to reach and remove the contaminants in certain locations, especially in the floors. Building floors are generally made with concrete, a material that is porous and undergoes cracking. Contaminants and bacteria are likely to accumulate in the superficial pores and cracks, from where it can be quite difficult to wash out. Even when it is recovered with a flooring system such as tiles, paint, epoxy or other common systems, it is vulnerable to penetration of the contaminants in the joint areas and in any other area where the cover is disrupted (wear, impacts, debonding, crack reflection from the substrate, etc.)

There thus remains a need for an improved method of treating (i.e. repairing, protecting, sanitizing and facilitating sanitation) of the internal surfaces of industrial buildings. The present invention seeks to meet this and other needs.

### OBJECT OF THE INVENTION

An object of the present invention is to provide an improved method for treating the internal surfaces of industrial buildings.

### SUMMARY OF THE INVENTION

More specifically, in accordance with the present invention, there is provided a method for treating an inner surface of a building, this treating comprising repairing and/or protecting and/or sanitizing and/or facilitating sanitation, the method comprising: preparing an inner building surface that is to be treated so as to render the surface able to receive a calcium aluminate cement-based mortar (CA cement-based mortar); applying on the prepared surface the CA cement-based mortar; and applying to the surface with the CA cement-based mortar a resurfacing system comprising an impermeable and deformable coating.

In accordance with another aspect of the invention there is provided a method for treating an inner surface of a building, this treating comprising repairing and/or protecting and/or sanitizing and/or facilitating sanitation, the method comprising: preparing an inner building surface that is to be treated so as to render the surface able to receive mortar and a resurfacing system comprising a poly-urea coating; applying mortar on the prepared surface; and applying to the surface with the mortar the resurfacing system comprising the poly-urea coating.

In an embodiment, the building comprises an industrial building. In an embodiment, the building is selected from the group consisting of: an agro-food building and a medical building. In an embodiment, the surface is selected from the group consisting of: a floor surface, a wall surface, a ceiling surface and any combination thereof.

In an embodiment, applying the CA cement-based mortar comprises correcting deficiencies on the surface and/or comprises overlaying the surface with the CA cement-based mortar. In an embodiment, the surface deficiencies are selected from the group consisting of cracks, cavities, abrasion, scaling, bruising, spalling, delaminating, disintegration, inadequate profile and any combination thereof.

In an embodiment, the CA cement-based mortar comprises from about 37% of weight to about 52% of weight of Alumina (A), from about 36% of weight to about 42% of weight of Lime (C), from about 1% of weight to about 17% of weight of Iron oxide (F), and from about 3% of weight to about 8% of weight of Silica (S).

In an embodiment, applying the mortar comprises correcting deficiencies on the surface and/or overlaying the surface with the mortar.

In an embodiment, preparing further comprises rendering the surface able to receive a resurfacing system comprising an impermeable and deformable coating. In an embodiment, the impermeable and deformable coating comprises a poly-urea coating. In an embodiment, the resurfacing system comprises a primary coating applied before the impermeable and deformable coating. In an embodiment, the primary coating addresses surface unevenness. In an embodiment, the primary coating comprises a bonding agent for creating proper adhesion between the surface and the poly-urea coating. In an embodiment, the primary coating comprises epoxy-based materials. resurfacing system is applied by vaporization.

In an embodiment, preparing further comprises a step selected from the group consisting of removing any existing covering on the surface, removing any deteriorated material on the surface, decontaminating the surface, cleaning the surface and any combination thereof. In an embodiment, cleaning comprises applying at least one cleaning agent on the surface. In an embodiment, the cleaning agent is selected from the group consisting of: hot water, organic solvents, acids, muriatic acids, oxidizing bleaches, reducing bleaches, acidic materials, degreasing agents, acetone, alcohol, and any combination thereof. In an embodiment, cleaning is selected from the group consisting of shotblasting, scarification, milling and any combination thereof.

In an embodiment, the method further comprises assessing the condition of the surface before the surface-preparing step. In an embodiment, assessing the condition of the surface comprises sampling the surface and the corresponding subsurface so as to obtain a sample thereof; and analyzing the sample. In an embodiment, assessing the condition of the surface further comprises visual inspection and/or hammer sounding of the surface before sampling. In an embodiment, the condition assessment is selected from the group consisting of: determining the compressive strength of the sample; analyzing the cracking pattern and the other signs of deterioration on the surface and the sample; ascertaining the presence and depth of penetration of any contaminant in the sample and any combination thereof.

In an embodiment, the method further comprising installing anchorages and a reinforcing mesh between the CA cement-based mortar and the surface to be treated.

In accordance with a further aspect of the present invention, there is provided a method for treating an inner surface of a building, this treating comprising repairing and/or protecting and/or sanitizing and/or facilitating sanitation, the method comprising: (a) evaluating the condition of the surface to be treated; (b) rendering the surface able to receive the various products used during the subsequent steps hereof; (c) repairing any surface deficiencies such as differences in surface level; (d) installing anchorages and a reinforcing mesh; (e) adjusting the height of gutters and edges of drains; (f) restoring/correcting the slope; (g) applying a bonding agent to correct surface unevenness or irregularities and create proper bonding between final coating to be applied and the surface to be treated; and (h) applying a final coating on the surface

In an embodiment, step (a) comprises: sampling the surface and the corresponding subsurface so as to obtain a sample thereof; and analyzing the sample. In an embodiment, step (a) further comprises visual inspection and/or hammer sounding of the surface before sampling. In an embodiment, evaluating the condition in step (a) is selected from the group consisting of: determining the compressive strength of the sample; analyzing the cracking pattern and the other signs of deterioration on the surface and the sample; ascertaining the presence and depth of penetration of any contaminant in the sample and any combination thereof.

In an embodiment, step (b) further comprises a step selected from the group consisting of removing any existing covering on the surface, removing any deteriorated material on the surface, decontaminating the surface, cleaning the surface and any combination thereof. In an embodiment, cleaning comprises applying at least one cleaning agent on the surface. In an embodiment, the cleaning agent is selected from the group consisting of: hot water, organic solvents, acids, muriatic acids, oxidizing bleaches, reducing bleaches, acidic materials, degreasing agents, acetone, alcohol, and any combination thereof. In an embodiment, cleaning is selected from the group consisting of shotblasting, scarification, milling and any combination thereof.

In an embodiment, step (c) comprises applying mortar. In an embodiment, the mortar comprises a calcium aluminate cement-based mortar (CA cement-based mortar).

In an embodiment, the bonding agent comprises epoxy.

In an embodiment, the coating comprises poly-urea.

The term “treating” should be construed herein to include without limitation: repairing, protecting, sanitizing, facilitating sanitation and any combination thereof.

The term “substrate” should be construed herein to include without limitation: the surface that is destined to be treated and the corresponding subsurface.

The term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or”.

Other objects, advantages and features of the present invention will become more apparent upon reading of the following non restrictive description of embodiments thereof, given by way of example only with reference to the accompanying drawings.

### BRIEF DESCRIPTION OF THE DRAWINGS

In the appended drawings where like elements are referenced by like reference numerals and in which:

FIG. 1 shows a schematic example of a surface treated with a poly-urea/epoxy coating on top of calcium aluminate-based mortar overlay, the treated surface being contiguous with a non-treated surface, in accordance with an embodiment of the present invention;

FIG. 2 shows a schematic example of a surface treated, with a poly-urea/epoxy coating covering contiguous zones, one overlaid with a calcium aluminate cement-based mortar and the other simply prepared to receive the coating system, in accordance with an embodiment of the present invention; and

FIG. 3 shows a schematic example of a treated surface with the poly-urea/epoxy coating system being applied directly on the prepared surface, except next to a contiguous non treated surface, where the a trench is dug in the substrate and is partially filled with a calcium-aluminate based mortar, in accordance with an embodiment of the present invention.

### DESCRIPTION OF THE EMBODIMENTS

With reference to the appended drawings embodiments of the invention will be herein described so as to exemplify the invention only and by no means limit the scope thereof.

Within an integrated surface treatment method, the present invention combines surface preparation, repair and/or overlay of the existing substrate (i.e. surface portion to be treated) and the application of a coating system which is impermeable, has no joint, is non-toxic (once hardened) and can sustain quite significant cracking of the underneath slab without getting torn apart. The absence of joints and the fact that it allows movement of the slab without cracking itself allow the system to protect the slab quite effectively against most common sources of contamination.

The present method for repairing and protecting the internal surfaces of buildings and hence, sanitizing or facilitating sanitation of buildings, comprises a variety of steps and can be used to facilitate sanitization/disinfection of the floors, walls and/or ceilings of industrial building such as agro-food processing plants and other food or medical-related buildings and the like. Depending on the condition of the surface to be treated, the process or method herein may range from a simple resurfacing to a series of more elaborate operations involving analysis and treatment of the existing surface, repairing and resurfacing.

In an embodiment, the present invention comprises:

(a) evaluating the condition of the surface(s) to be treated;

(b) rendering the surface able to receive the various products used during the subsequent steps hereof;

(c) repairing deficiencies such as any differences in surface level;

(d) installing anchorages and a reinforcing mesh;

(e) adjusting the height of gutters and edges of drains;

(f) restoring/correcting the slope;

(g) applying a bonding agent to correct surface unevenness or irregularities so as to provide a smooth surface and create proper bonding between the poly-urea (or any equivalent) coating and the surface to be treated; and

(h) applying a poly-urea (or any equivalent) coating on the surface

More specifically, in an embodiment, the present invention comprises the following steps:

Condition Evaluation

The first step consists of inspecting the surfaces to be treated to assess their condition. In the case of concrete, the operation begins with a thorough visual inspection and the hammer sounding of the surface to detect voids and other type of internal defects underneath the surface. When necessary, samples are taken. In the case of concrete surfaces, the samples allow for the concrete compressive strength resistance of the slab of concrete to be evaluated, cracking patterns to be determined and, where applicable, the contaminant(s) present in the concrete to be identified (type, concentration, depth, and other parameters as is known in the art).

Hence, initially, the site will be inspected to assess the condition of the surfaces to be treated and detect and identify distresses. For each problem zone showing one or more specific deteriorated or contaminated areas, samples are taken (in concrete elements, the operation is performed by core drilling) for analysis.

The samples are first analyzed visually to determine the nature and depth of the contaminants as part of an initial analysis. This operation also determines whether any repair work has already been done and identifies the various materials used. It also provides =a way to detect and locate the presence of distress such as cracks, voids, disintegration or corrosion of the steel reinforcement, amongst other characteristics known in the art.

Compressive strength tests are performed on cored specimens. The measured strength allows a gross evaluation of the quality and mechanical integrity of the concrete in place.

The results of the analysis basically determine what surface preparation measures are required on the substrate. Where walls or ceiling made of materials other than concrete have to be covered and if they are already painted or coated, pullout tests must be conducted using specialized equipment. The results obtained reflect the quality and intensity of the bond between the paint/coating and the substrate. Depending on the quality of the bond, appropriate operations are recommended.

Exposing a Sound and Clean Substrate

This step involves removal of deteriorated material and/or decontamination and/or cleaning the existing surface using mechanical tools or cleaning agents to make it able to receive the various products used during the subsequent steps.

Depending on the results of the condition evaluation, different measures may need to be taken.

In the case of sound, clean and non-contaminated concrete surfaces, they are simply roughened by shotblasting and then cleaned with high-pressure air or water.

Where the concrete surface is in good overall condition but it is superficially contaminated, shotblasting is to be followed by thorough cleaning products such as degreasing agents, acetone, alcohol and/or other products suited for the type of contamination to be addressed. The first step is to identify the contaminant and then choose a cleaning agent(s) and method(s) accordingly.

Cleaning with muriatic acid is done in the case of carbonation of the concrete since it can prevent the development of proper adherence between the substrate and the bonding agent.

In situations where the concrete deterioration is important and/or the extent of contamination exceeds considerably the superficial layer, scarification or milling might be required to remove a more significant depth of concrete and expose a surface suitable to obtaining adequate adhesion between the substrate and the resurfacing system to be put in place.

On walls and ceilings made of material other than concrete, when contamination is present or if the bond between the surface and existing paint/coating is inadequate, appropriate removal operations are conducted.

Repair of Substrate

This step consists of repairing and leveling the prepared surface with a calcium aluminate cement-based (CA cement-based) mortar.

After setting CA cement based mortar once applied see their free moisture content decrease chemically as opposed to drying via evaporation, much more rapidly than in the case of traditional cement-based mortars. Ordinary cement-based mortar takes a few days to dry, while the CA cement-based mortars of the present invention dry up in a few hours. This behavior makes the compatible with maintenance work during industrial shutdowns, which generally need to be completed within extremely tight schedules.

In an embodiment, the CA cement-based mortar of the invention comprises from about 37% of weight to about 52% of Alumina (A), from about 36% of weight to about 42% of weight of Lime (C), from about 1% of weight to about 17% of weight of Iron oxide (F), and from about 3% of weight to about 8% of weight of Silica (S).

Where applicable, the substrate has to be repaired prior the application of the resurfacing system. Where there are large cavities, wide cracks or inconvenient level differences between adjacent parts of the surface, the CA cement-based mortar is used to correct the deficiency. Depending on their width and extent, cracks in the substrate might need to be filled with a grout.

In applications deeper than 25 mm, the CA cement-based mortar must be extended with ⅜″ washed, dried pea gravel.

On walls and ceilings, where deficiencies such as holes and cracks are detected, appropriate remedial operations are conducted as will be understood by the skilled artisan.

Anchoring the Overlay (Floors)

This step consists of installing the anchorages and the reinforcing mesh.

To ensure good performance and durability of the mortar overlay, it is necessary to provide a proper mechanical connection with the substrate. To do so, a reinforcing mesh is anchored into the substrate, which helps minimizing cracking in the overlay and prevents debonding, if any, to propagate.

The anchoring method consists of installing a reinforcing mesh (metallic or composite mesh), which is secured in place using special anchorages embedded into the substrate using a pneumatic sealing gun. The gun uses cartridges with variable charges. The charge to be used is determined by the quality and strength of the substrate. The anchorages are staggered every 400 mm (16 in.) in both x-y directions and the mesh is raised from the surface between the anchorages to ensure a proper embedment by the mortar and thus maximize the reinforcing effect of the mesh.

Gutter Height Adjustment (Floors)

This step consists of adjusting the height of the gutters and the edges of the drains.

hen little or no concrete is removed in the surface preparation step and the floor surface is raised in the step described below (thickness of the overlay and/or corrections of the grade to improve the comfort of workers and facilitate movement of vehicles), the surrounding gutters should be raised accordingly, prior to casting the overlay.

Overlay for Repair, Leveling and Drainage Slopes (Floors)

This step consists of restoring the surface and/or correcting the slopes, according to the needs, with a CA cement-based mortar.

The use of a CA cement-based mortar allows an early and durable installation of the resurfacing system on the floors to be treated. In addition to having excellent mechanical properties and showing good resistance to the penetration of water and contaminants, the CA cement-based mortar, because of its intrinsically low free water content early in the hydration process, is very well adapted to a quick application of the resurfacing system.

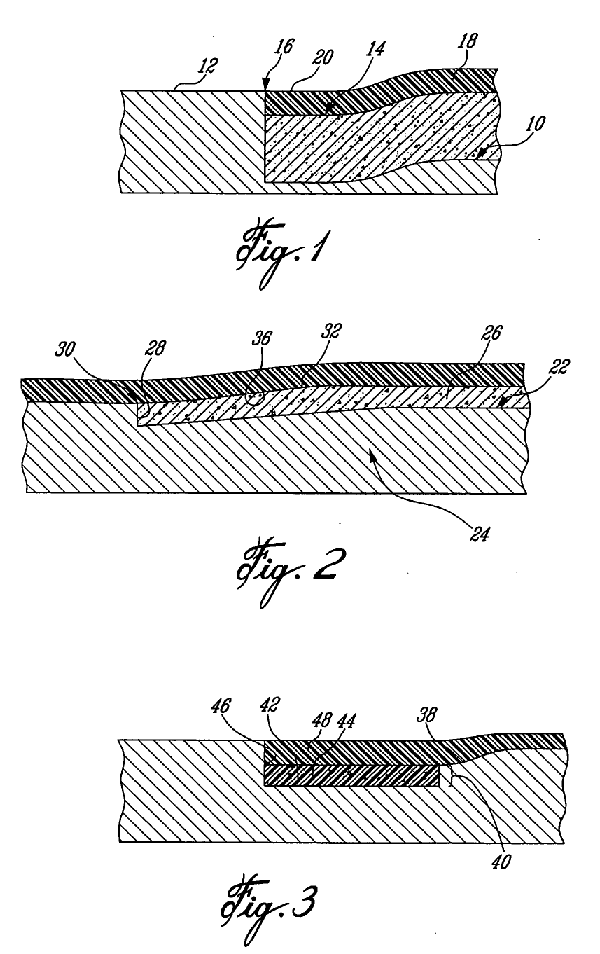

With reference to FIG. 1, where a floor 10 to be treated needs to be repaired and is adjacent to an existing floor 12 not to be treated, the overlay level 14 next to the joint 16 should be lowered by a thickness equivalent to that of the resurfacing system 18 including, primary and final coatings of epoxy and poly-urea respectively, such that the final surface 20 of the treated floor 10 and that of the adjacent floor 12 are at the same level thus avoiding a feather edge joint.

With reference to FIG. 2, where a floor 22 to be treated needs repairs only on a portion 24 of the surface, the depth of the CA cement-based mortar 26 overlay will be increased on the boundaries 28 of the repaired zone 24 to maintain the minimum required thickness of mortar throughout. The length over which the overlay depth is increased near the joint 30 is adjusted such as ensuring a transition slope compatible with the needs and requirements of users. A resurfacing system 32 including primary and final coatings of epoxy and poly-urea can be used to cover both the surface 34 of the CA cement-based mortar 26 as well as the adjacent non-treated surface 36.

With reference to FIG. 3, at the boundaries of a floor 38 to be treated where no overlay is applied, a 10 mm (⅜ in.) deep trench 40 is dug mechanically. At the bottom 42 of the trench, an epoxy-based mortar 44 is applied and finished with a specially designed trowel. The cavity 46 is then filled with the final coating 48 of poly-urea during the last step of the process thus avoiding a feather edge joint. This technique is also used for doorsills.

In applications deeper than 25 mm, the CA cement-based mortar must be extended with ⅜″ washed, dried pea gravel.

Application of a Primary Coating

This step consists of applying a primary coating to level-off slight residual surface unevenness and create proper bonding between the final coating and the prepared surface (either overlaid or not). The primary coating can be epoxy-based.

At the end of the CA cement-based mortar curing period (the duration of which depends on the CA cement-based mortar composition, the ambient temperature and relative humidity, and the temperature of the substrate), a suitable primary coating is applied over the entire surface to be treated. The purpose of this coating, which is generally epoxy-based, is to fill the residual surface imperfections and improve bond between the final coating and the substrate (either overlaid or not). It can be applied either by spraying, rolling and/or with a squeegee-type spreader. The compatibility between the primary coating and the final coating must be checked for prior to the work.

Final Coating

The last step of the process is to completely cover the surface with the final poly-urea (or equivalent) coating.

This consists of applying a final poly-urea (or equivalent) coating by spraying the surfaces to create a smooth regular finish or a non-slip finish, depending on the needs of the user. The applicator can spray poly-urea droplets on the surface in order to provide the required degree of roughness.

On the most heavily used areas, the thickness of the coating should be of the order of 2.0 to 2.5 mm (80 to 100 mils).

In an embodiment, the spraying pressure should be maintained at 2500±200 psi throughout the application process. In an embodiment, the material temperature should be maintained between 50 and 70° C. Poly-urea hardens quickly and, although it is possible to walk on the surface 24 hours after it is applied, reaches approximately 90% of its ultimate strength at about seven days. A seven-day curing period should be allowed before submitting the new poly-urea surface to normal use.

During application, areas where poly-urea (or equivalent) will not be applied must be covered to prevent contamination by spray (accumulation of fine droplets in suspension).

Equivalent coatings to poly-urea should be non-porous, impermeable and joint-free. They should also be elastic or deformable enough so as to provide adequate crack-bridging characteristics and prevent crack reflection from the substrate.

In another embodiment, the present method uses other overlay mortars other than CA cement-based mortar described herein, such as Portland mortar for example, with a final poly-urea coating.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention as defined in the appended claims.

What is claimed is:

1. A method for treating an inner surface of a building, said treating comprising repairing and/or protecting and/or sanitizing and/or facilitating sanitation, said method comprising:
preparing an inner building surface that is to be treated so as to render said surface able to receive a calcium aluminate cement-based mortar (CA cement-based mortar);
applying on said prepared surface said CA cement-based mortar; and
applying to said surface with said CA cement-based mortar a resurfacing system comprising an impermeable and deformable coating.

2. A method according to claim 1, wherein said building is selected from the group consisting of: an industrial building, an agro-food building and a medical building.

3. A method according to claim 1, wherein said surface is selected from the group consisting of: a floor surface, a wall surface, a ceiling surface and any combination thereof.

4. A method according to claim 1, wherein said applying said CA cement-based mortar comprises a step selected from the group consisting of: correcting deficiencies on said surface, overlaying said surface with said CA cement-based mortar and any combination thereof.

5. A method according to claim 1, wherein said CA cement-based mortar comprises from about 37% of weight to about 52% of weight of Alumina (A), from about 36% of weight to about 42% of weight of Lime (C), from about 1% of weight to about 17% of weight of Iron oxide (F), and from about 3% of weight to about 8% of weight of Silica (S).

6. A method according to claim 4, wherein said surface deficiencies are selected from the group consisting of cracks, cavities, abrasion, scaling, bruising, spalling, delaminating, disintegration, inadequate profile and any combination thereof.

7. A method according to claim 1, wherein said preparing further comprises rendering said surface able to receive said impermeable and deformable coating.

8. A method according to claim 1, wherein said impermeable and deformable coating comprises a poly-urea coating.

9. A method according to claim 1, wherein said resurfacing system comprises a primary coating applied before said impermeable and deformable coating.

10. A method according to claim 9, wherein said primary coating addresses surface unevenness.

11. A method according to claim 9, wherein said primary coating comprises a bonding agent for creating proper adhesion between said surface and said poly-urea coating.

12. A method according to claim 9, wherein said primary coating comprises epoxy-based materials.

13. A method according to claim 1, wherein said resurfacing system is applied by vaporization.

14. A method according to claim 1, wherein said preparing further comprises a step selected from the group consisting of removing any existing covering on said surface, removing any deteriorated material on said surface, decontaminating said surface, cleaning said surface and any combination thereof.

15. A method according to claim 14, wherein said cleaning comprises applying at least one cleaning agent on said surface.

16. A method according to claim 15, wherein said cleaning agent is selected from the group consisting of: hot water, organic solvents, acids, muriatic acids, oxidizing bleaches, reducing bleaches, acidic materials, degreasing agents, acetone, alcohol, and any combination thereof.

17. A method according to any one of claims 14, wherein said cleaning is selected from the group consisting of shotblasting, scarification, milling and any combination thereof.

18. A method according to claim 1, wherein said method comprises assessing the condition of said surface before said surface preparing step.

19. A method according to claim 18, wherein said assessing the condition of said surface comprises:
sampling said surface and the corresponding subsurface so as to obtain a sample thereof; and
analyzing said sample.

20. A method according to claim 18, wherein said assessing the condition of said surface further comprises visual inspection and/or hammer sounding of said surface before said sampling.

21. A method according to claim 18, wherein said condition assessment is selected from the group consisting of: determining the compressive strength of the said sample; analyzing the cracking pattern and the other signs of deterioration on said surface and said sample; ascertaining the presence and depth of penetration of any contaminant in the sample and any combination thereof.

22. A method according to claim 1, further comprising installing anchorages and a reinforcing mesh between said CA cement-based mortar and said surface to be treated.

23. A method for treating an inner surface of a building, said treating comprising repairing and/or protecting and/or sanitizing and/or facilitating sanitation, said method comprising:
preparing an inner building surface that is to be treated so as to render said surface able to receive mortar and a resurfacing system comprising a poly-urea coating;
applying on said prepared surface said mortar; and
applying to said surface with said mortar said resurfacing system comprising said poly-urea coating.

24. A method according to claim 23, wherein said applying said mortar comprises step selected from the group consisting of correcting deficiencies on said surface, overlaying said surface with said mortar and any combination thereof.

25. A method according to claim 24, wherein said surface deficiencies are selected from the group consisting of cracks, cavities, abrasion, scaling, bruising, spalling, delaminating, disintegration, inadequate profile and any combination thereof.

26. A method according to any one of claims 23, wherein said resurfacing system further comprises a primary coating applied before said impermeable and deformable coating.

27. A method according to claim 23, wherein said primary coating addresses surface unevenness.

28. A method according to claim 23, wherein said primary coating comprises a bonding agent for creating proper adhesion between said surface and said poly-urea coating.

29. A method according to claim 23, wherein said primary coating comprises epoxy-based materials.

30. A method according to claim 23, wherein said resurfacing system is applied by vaporization.

31. A method according to claim 24, wherein said preparing further comprises a step selected from the group consisting of removing any existing covering on said surface, removing any deteriorated material on said surface, decontaminating said surface, cleaning said surface and any combination thereof.

32. A method according to claim 23, wherein said method further comprises assessing the condition of said surface before said surface preparing step.

33. A method according to claim 32, wherein said assessing the condition of said surface comprises:
sampling said surface and the corresponding subsurface so as to obtain a sample thereof; and
analyzing said sample.

34. A method according to claim 32, wherein said assessing the condition of said surface further comprises visual inspection and/or hammer sounding of said surface before said sampling.

35. A method according to claim 1, further comprising installing anchorages and a reinforcing mesh between said mortar and said surface to be treated.

36. A method for treating an inner surface of a building, said treating comprising repairing and/or protecting and/or sanitizing and/or facilitating sanitation, said method comprising:
(a) evaluating the condition of the surface to be treated;
(b) rendering the surface able to receive the various products used during the subsequent steps hereof;
(c) repairing surface deficiencies;
(d) installing anchorages and a reinforcing mesh;
(e) adjusting the height of gutters and edges of drains;
(f) restoring/correcting the slope;
(g) applying a bonding agent to correct surface irregularities and create proper bonding between final coating to be applied and the surface to be treated; and
(h) applying a final coating on the surface

37. A method according to claim 36, wherein said step (a) comprises:
sampling said surface and the corresponding subsurface so as to obtain a sample thereof; and
analyzing said sample.

38. A method according to claim 37, wherein said step (a) further comprises visual inspection and/or hammer sounding of said surface before said sampling.

39. A method according to claim 36, wherein said step (b) further comprises a step selected from the group consisting of removing any existing covering on said surface, removing any deteriorated material on said surface, decontaminating said surface, cleaning said surface and any combination thereof.

40. A method according to claim 36, wherein said step (c) comprises applying mortar.

41. A method according to claim 53, wherein said mortar comprises a calcium aluminate cement-based mortar (CA cement-based mortar).

42. A method according to claim 36, wherein said bonding agent comprises epoxy.

43. A method according to claim 36, wherein said coating comprises poly-urea.
